(19) United States
(12) Patent Application Publication
(10) Pub. No.: US 2025/0111977 A1
(43) Pub. Date: Apr. 3, 2025

(54) ELECTRONIC COMPONENT

(71) Applicant: TDK Corporation, Tokyo (JP)

(72) Inventors: Nobuyuki OKUZAWA, Tokyo (JP); Munehiro Takaku, Tokyo (JP)

(73) Assignee: TDK Corporation, Tokyo (JP)

(21) Appl. No.: 18/775,370

(22) Filed: Jul. 17, 2024

(30) Foreign Application Priority Data
Oct. 3, 2023 (JP) 2023-172185

(51) Int. Cl. H01F 17/00; H01F 27/29; H01F 27/32

(52) U.S. Cl. CPC H01F 17/0013; H01F 27/292; H01F 27/323

(57) ABSTRACT

A coil component includes an element body, a first terminal electrode, a second terminal electrode, a first conductor disposed at a position closer to a principal surface in the element body and electrically connected to the first terminal electrode and the second terminal electrode, and a second conductor disposed at a position closer to a principal surface in the element body and electrically connected to the first terminal electrode and the second terminal electrode. The element body is formed of a material having light permeability, and an identification portion formed of a material different from a material of the first conductor is provided on a first surface facing the principal surface in the first conductor.

### TECHNICAL FIELD

The present disclosure relates to an electronic component.

### BACKGROUND

Japanese Unexamined Patent Publication No. 2015-141945 discloses an electronic component that includes an insulator made of a resin, a coil provided in the insulator, and a terminal electrode electrically connected to the coil and disposed on a mounting surface of an element body. The coil includes a first conductor, a second conductor, and a connecting portion connecting the first conductor and the second conductor.

### SUMMARY

In the electronic component as described above, it is difficult to distinguish at a glance a surface other than the mounting surface of the element body on which the terminal electrode is disposed. In particular, it is difficult to distinguish between the side surface and principal surface (surface facing the mounting surface) of the element body in the electronic component. Therefore, in the electronic component, it is difficult to identify the direction.

An object of one aspect of the present disclosure is to provide an electronic component capable of identifying the direction of the electronic component.

(1) An electronic component according to an aspect of the present disclosure including: an element body formed by laminating a plurality of insulating layers, and including a mounting surface and a principal surface facing the mounting surface; a pair of terminal electrodes disposed on the mounting surface of the element body; a first conductor disposed at a position close to the principal surface in the element body and electrically connected to the pair of terminal electrodes; and a second conductor disposed at a position closer to the mounting surface in the element body and electrically connected to the pair of terminal electrodes, wherein the element body is formed of a material having light permeability, and an identification portion formed of a material different from a material of the first conductor is provided on a surface of the first conductor facing the principal surface.

In the electronic component according to one aspect of the present disclosure, the element body is formed of a material having light permeability. In this configuration, the identification portion formed of a material different from a material of the first conductor is provided on the surface of the first conductor facing the principal surface. As a result, in the electronic component, the first conductor and the identification portion can be distinguished from each other when the element body is viewed, so that the identification portion can be recognized. Therefore, in the electronic component, the first conductor can be recognized by the identification portion, so that the orientation (position) of the first conductor can be recognized. Therefore, in the electronic component, the direction (orientation) of the electronic component can be identified.

(2) In the electronic component of (1), the material forming the identification portion may have a higher light reflectance than a light reflectance of the material forming the first conductor. In this configuration, the light reflectances of the first conductor and the identification portion are different from each other, so that the identification portion can be more easily recognized.

(3) In the electronic component of (1) or (2), the first conductor may be formed of a material containing Cu as a main component, and the identification portion may be formed of a material containing Cr, Ti, or NiCr as a main component. In this configuration, the first conductor and the identification portion are formed of different materials, so that the first conductor and the identification portion can be distinguished from each other.

(4) The electronic component according to any one of (1) to (3) may further include a connection conductor disposed in the element body, extending in a direction in which the mounting surface and the principal surface face each other, and connecting the first conductor and the second conductor. In this configuration, the first conductor, the second conductor, and the connection conductor constitute a coil.

(5) In the electronic component according to any one of (1) to (4), the pair of terminal electrodes may be embedded in the element body, and the surfaces of the pair of terminal electrodes may not protrude from the mounting surface. As described above, in the configuration in which the pair of terminal electrodes is embedded in the element body, it is difficult to recognize the terminal electrodes, so that it is difficult to recognize the direction of the electronic component at a glance. Therefore, the above configuration is particularly effective in the configuration in which the pair of terminal electrodes is embedded in the element body.

(6) An electronic component according to an aspect of the present disclosure including: an element body formed by laminating a plurality of insulating layers, and including a mounting surface and a principal surface facing the mounting surface; a pair of terminal electrodes disposed on the mounting surface of the element body; a first conductor disposed at a position closer to the principal surface in the element body; and a second conductor disposed at a position closer to the mounting surface in the element body, wherein the element body is formed of a material having light permeability, and a distance between the first conductor and the principal surface is shorter than a distance between the second conductor and the mounting surface.

In the electronic component according to one aspect of the present disclosure, the element body is formed of a material having light permeability. In this configuration, the distance between the first conductor and the principal surface is shorter than the distance between the second conductor and the mounting surface. As a result, in the electronic component, the first conductor is more easily visually recognized than the second conductor when the element body is viewed, so that the first conductor can be recognized. Therefore, in the electronic component, the orientation (position) of the first conductor can be recognized. Therefore, in the electronic component, the direction (orientation) of the electronic component can be identified.

(7) In the electronic component of (6), the first conductor may not be electrically connected to the pair of terminal electrodes, and the second conductor may be electrically connected to the pair of terminal electrodes. The first conductor is a so-called dummy conductor. In this configuration, even when the inductor includes only the second conductor, the first conductor that is the dummy conductor is provided, so that the first conductor can be recognized. Therefore, in the electronic component, the orientation (position) of the first conductor can be recognized. Therefore, in the electronic component, the direction (orientation) of the electronic component can be identified.

(8) In the electronic component of (6) or (7), the first conductor and the second conductor may be formed of a material containing Cu as a main component.

(9) The electronic component of (6) may further include a connection conductor disposed in the element body, extending in a direction in which the mounting surface and the principal surface face each other, and connecting the first conductor and the second conductor. In this configuration, the first conductor, the second conductor, and the connection conductor constitute a coil.

(10) In the electronic component of (6) to (9), the pair of terminal electrodes may be embedded in the element body, and the surfaces of the pair of terminal electrodes may not protrude from the mounting surface. As described above, in the configuration in which the pair of terminal electrodes is embedded in the element body, it is difficult to recognize the terminal electrodes, so that it is difficult to recognize the direction of the electronic component at a glance. Therefore, the above configuration is particularly effective in the configuration in which the pair of terminal electrodes is embedded in the element body.

According to one aspect of the present disclosure, the direction of the electronic component can be identified.

### BRIEF DESCRIPTION OF THE DRAWINGS

FIG. 1 is a perspective view of an electronic component according to a first embodiment;

FIG. 2 is a view of the electronic component illustrated in FIG. 1 as viewed from a side surface side;

FIG. 3 is a view of the electronic component illustrated in FIG. 1 as viewed from a principal surface side;

FIG. 4 is an enlarged view of a part of a first conductor;

FIG. 5 is a perspective view of an electronic component according to a second embodiment;

FIG. 6 is a view of the electronic component illustrated in FIG. 5 as viewed from a side surface side;

FIG. 7 is a view of the electronic component shown in FIG. 5 as viewed from a principal surface side; and

FIG. 8 is an enlarged view of a part of a first conductor.

### DETAILED DESCRIPTION

In the following, preferred embodiments of the present disclosure will be described in detail with reference to the accompanying drawings. Note that, the same or corresponding elements in the description of the drawings are denoted by the same reference signs, and redundant description thereof is omitted.

### First Embodiment

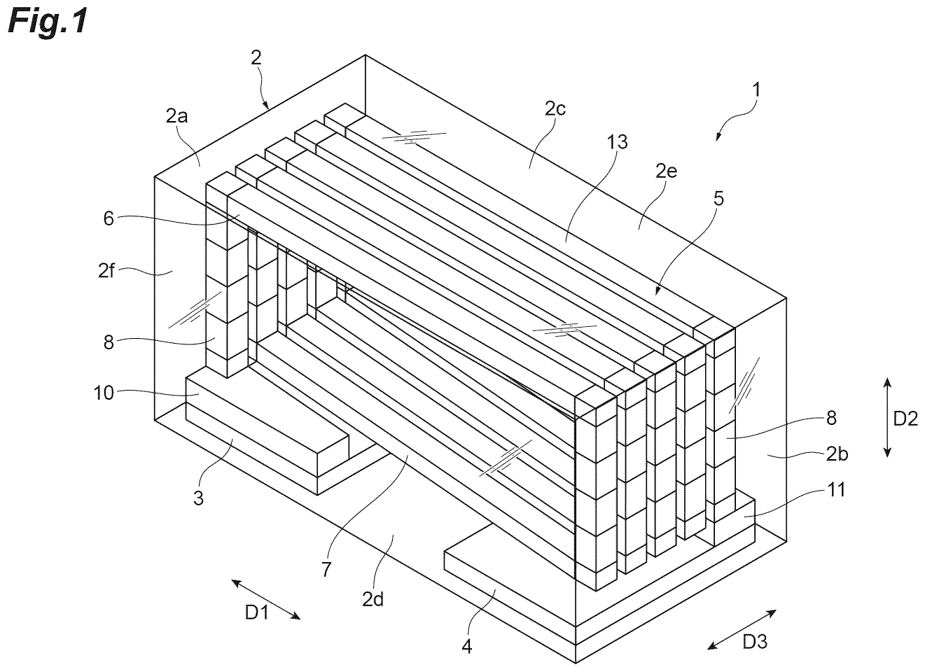

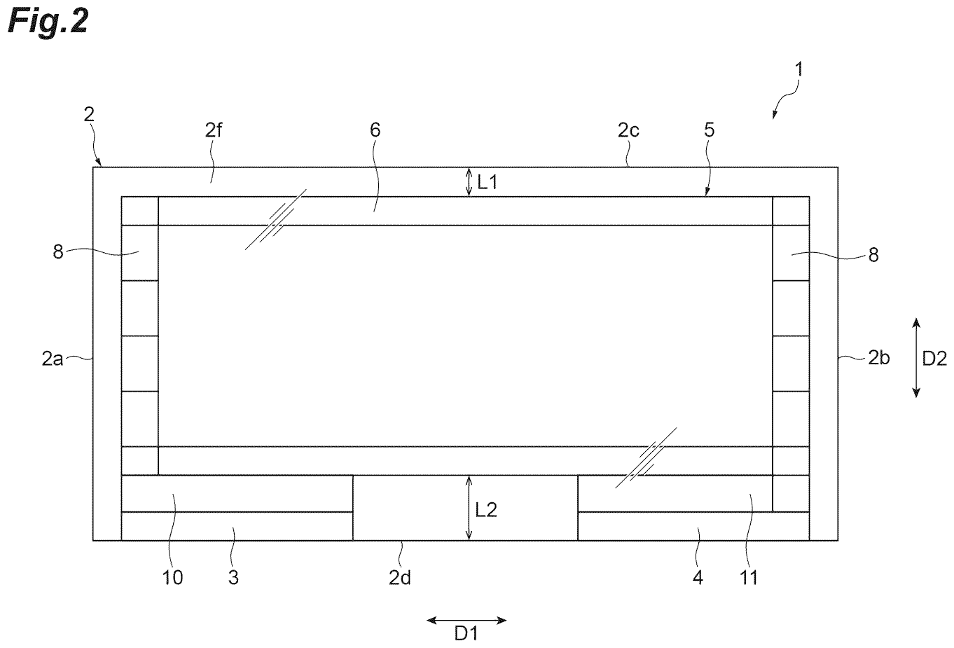

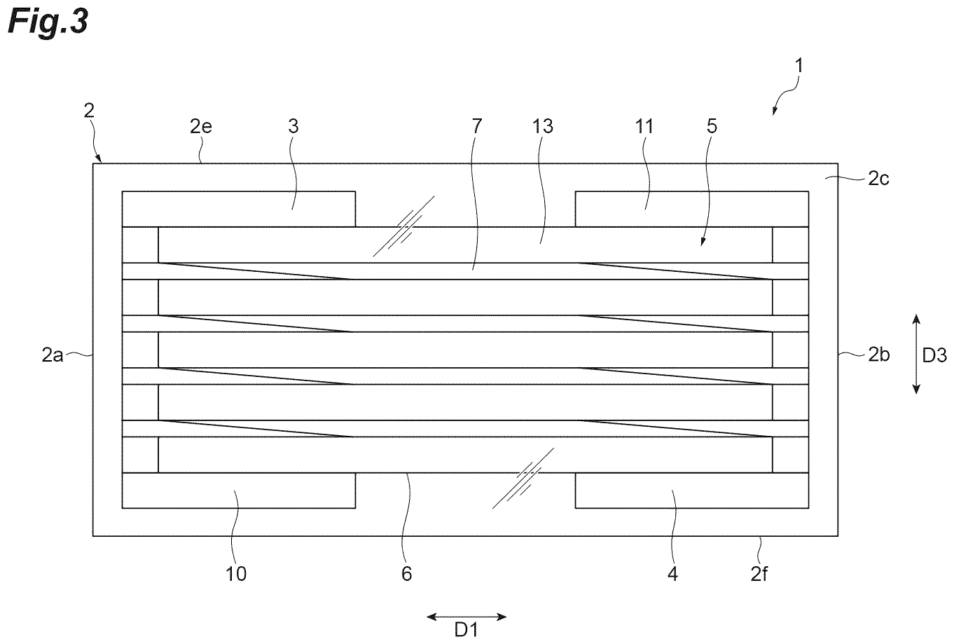

An electronic component according to a first embodiment will be described. FIG. 1 is a perspective view of an electronic component according to a first embodiment. FIG. 2 is a view of the electronic component illustrated in FIG. 1 as viewed from a side surface side. FIG. 3 is a view of the electronic component illustrated in FIG. 1 as viewed from a principal surface side. As illustrated in FIGS. 1 to 3, a coil component (electronic component) 1 includes an element body 2, a first terminal electrode 3, a second terminal electrode 4, a coil 5, a first connection conductor 10, and a second connection conductor 11.

The element body 2 has a rectangular parallelepiped shape. The rectangular parallelepiped shape includes a rectangular parallelepiped shape in which corner portions and ridge line portions are chamfered, or a rectangular parallelepiped shape in which corner portions and ridge line portions are rounded. The element body 2 has, as outer surfaces, a pair of end surfaces 2a and 2b, a pair of principal surfaces 2c and 2d, and a pair of side surfaces 2e and 2f. The end surfaces 2a and 2b face each other. The principal surfaces 2c and 2d face each other. The side surfaces 2e and 2f face each other. Hereinafter, a facing direction of the end surfaces 2a and 2b is referred to as a first direction D1, a facing direction of the principal surfaces 2c and 2d is referred to as a second direction D2, and a facing direction of the side surfaces 2e and 2f is referred to as a third direction D3. The first direction D1, the second direction D2, and the third direction D3 are substantially orthogonal to each other.

The end surfaces 2a and 2b extend in the second direction D2 so as to be connected to the principal surfaces 2c and 2d. The end surfaces 2a and 2b also extend in the third direction D3 so as to be connected to the side surfaces 2e and 2f. The principal surfaces 2c and 2d extend in the first direction D1 so as to be connected to the end surfaces 2a and 2b. The principal surfaces 2c and 2d also extend in the third direction D3 so as to be connected to the side surfaces 2e and 2f. The side surfaces 2e and 2f extend in the first direction D1 so as to be connected to the end surfaces 2a and 2b. The side surfaces 2e and 2f also extend in the second direction D2 so as to be connected to the principal surfaces 2c and 2d.

The principal surface 2d is a mounting surface, and is, for example, a surface facing another electronic device (for example, a circuit substrate or an electronic component) (not illustrated) when the coil component 1 is mounted on the another electronic device. The end surfaces 2a and 2b are surfaces continuous from the mounting surface (that is, the principal surface 2d).

In the case of the forms illustrated in FIGS. 1 to 3, a length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, the end surfaces 2a and 2b, the principal surfaces 2c and 2d, and the side surfaces 2e and 2f have a rectangular shape. The length of the element body 2 in the second direction D2 may be equal to the length of the element body 2 in the third direction D3, or may be longer than the length of the element body 2 in the third direction D3.

It should be noted that “equal” in the present embodiment may mean not only “equal” but also a value including a slight difference, a manufacturing error, or the like in a preset range. For example, when a plurality of values is included within a range of ±5% of an average value of the plurality of values, the plurality of values is defined to be equal.

The element body 2 is formed by laminating a plurality of element body layers (insulating layers) in the second direction D2. That is, a laminating direction of the element body 2 is the second direction D2. In the actual element body 2, the plurality of element body layers may be integrated to such an extent that boundaries between the layers cannot be visually recognized, or may be integrated such that boundaries between the layers can be visually recognized.

The element body 2 has visible light permeability (transparency). The element body 2 has a predetermined light transmittance. The element body 2 is formed of a material having permeability. The element body layer constituting the element body 2 may be, for example, a resin layer. A material of the element body layer includes, for example, at least one selected from a liquid crystal polymer, a polyimide resin, crystalline polystyrene, an epoxy resin, an acrylic resin, a bismaleide-based resin, and a fluorine-based resin. The element body layer may contain a filler. The filler may be, for example, an inorganic filler. Examples of the inorganic filler include silica (SiO₂). Note that the element body layer may not contain a filler.

Note that the element body layer may include a magnetic material. The magnetic material of the element body layer includes, for example, a Ni—Cu—Zn ferrite material, a Ni—Cu—Zn—Mg ferrite material, or a Ni—Cu ferrite material. The magnetic material of the element body layer may contain, for example, a Fe alloy. The element body layer may contain, for example, a nonmagnetic material. The nonmagnetic material of the element body layer includes, for example, a glass ceramic material or a dielectric material.

Each of the first terminal electrode 3 and the second terminal electrode 4 is provided in the element body 2. Each of the first terminal electrode 3 and the second terminal electrode 4 is disposed on the principal surface 2d of the element body 2. The first terminal electrode 3 and the second terminal electrode 4 are provided in the element body 2 to be separated from each other in the first direction D1. Specifically, the first terminal electrode 3 is disposed on a side of the end surface 2a of the element body 2. The second terminal electrode 4 is disposed on a side of the end surface 2b of the element body 2.

Each of the first terminal electrode 3 and the second terminal electrode 4 may have, for example, a rectangular shape (quadrilateral shape). Each of the first terminal electrode 3 and the second terminal electrode 4 is disposed such that each side is along the first direction D1 or the third direction D3. As shown in FIG. 2, the respective surfaces of the first terminal electrode 3 and the second terminal electrode 4 are flush with the principal surface 2d. That is, in the present embodiment, the first terminal electrode 3 and the second terminal electrode 4 do not protrude from the principal surface 2d. The first terminal electrode 3 and the second terminal electrode 4 are formed of a conductive material (for example, Cu).

Each of the first terminal electrode 3 and the second terminal electrode 4 may be provided with a plating layer (not illustrated) containing, for example, Ni, Sn, Au, or the like by electrolytic plating or non-electrolytic plating. The plating layer may include, for example, a Ni plating film containing Ni and covering the first terminal electrode 3 and the second terminal electrode 4, and an Au plating film containing Au and covering the Ni plating film.

As illustrated in FIGS. 1 to 3, the coil 5 is disposed in the element body 2. The coil 5 includes a plurality of first conductors 6, a plurality of second conductors 7, and a plurality of pillars (connection conductors) 8. The coil 5 is configured by electrically connecting the first conductors 6, the second conductors 7, and the pillars 8. A coil axis of the coil 5 is provided along the third direction D3. The plurality of first conductors 6, the plurality of second conductors 7, and the plurality of pillars 8 are formed of a conductive material. In the present embodiment, the plurality of first conductors 6, the plurality of second conductors 7, and the plurality of pillars 8 are formed of a material containing Cu as a main component. The first conductors 6, the second conductors 7, and the pillars 8 are disposed apart from the end surfaces 2a and 2b, the principal surfaces 2c and 2d, and the side surfaces 2e and 2f.

Each of the first conductors 6 is disposed at a position close to the principal surface 2c of the element body 2. Each of the first conductors 6 extends along the first direction D1. Each of the first conductors 6 connects two pillars 8. The first conductor 6 spans between two pillars 8. In the present embodiment, the first conductor 6 has a prismatic shape. The first conductor 6 has a rectangular cross section. One end portion (end portion on a side of the end surface 2a) of the first conductor 6 in the extending direction is connected to one end portion (end portion on a side of the principal surface 2c) of the pillar 8. The other end portion (end portion on a side of the end surface 2b) in the extending direction of the first conductor 6 is connected to one end portion (end portion on the side of the principal surface 2c) of the pillar 8.

Each of the second conductors 7 is disposed at a position closer to the principal surface 2d (mounting surface) of the element body 2. Each of the second conductors 7 extends in the first direction D1. Each of the second conductors 7 connects two pillars 8. The second conductor 7 spans between two pillars 8. In the present embodiment, the second conductor 7 has a prismatic shape. The second conductor 7 has a rectangular cross section. One end portion (end portion on a side of the end surface 2a) of the second conductor 7 in the extending direction is connected to the other end portion (end portion on a side of the principal surface 2d) of the pillar 8. The other end portion (end portion on a side of the end surface 2b) of the second conductor 7 in the extending direction is connected to the other end portion (end portion on a side of the principal surface 2d) of the pillar 8. The number of the plurality of second conductors 7 is smaller by one than the number of the plurality of first conductors 6. That is, when the number of the first conductors 6 is n, the number of the second conductors 7 is n-1.

Each of the pillars 8 extends along the second direction D2. The pillar 8 connects the first conductor 6 and the second conductor 7. In the present embodiment, the pillar 8 has a prismatic shape. The shape of the cross section of the pillar 8 (direction orthogonal to the second direction D2) is rectangular. The pillar 8 can be configured by laminating a plurality of pillar members in the second direction D2. One end portion of the pillar 8 is connected to an end portion of the first conductor 6. The other end portion of the pillar 8 is connected to the end portion of the second conductor 7.

The first connection conductor 10 connects the first terminal electrode 3 and one end portion of the coil 5. The first connection conductor 10 is connected to the other end portion of the pillar 8 of the coil 5. The first connection conductor 10 is disposed at a position close to the end surface 2a and close to the side surface 2e. The first connection conductor 10 is made of a conductive material. The first connection conductor 10 is formed of, for example, Cu.

The second connection conductor 11 connects the second terminal electrode 4 and the other end portion of the coil 5. The second connection conductor 11 is connected to the other end portion of the pillar 8 of the coil 5. The second connection conductor 11 is disposed at a position close to the end surface 2b and close to the side surface 2f. The second connection conductor 11 is made of a conductive material. The second connection conductor 11 is formed of, for example, Cu.

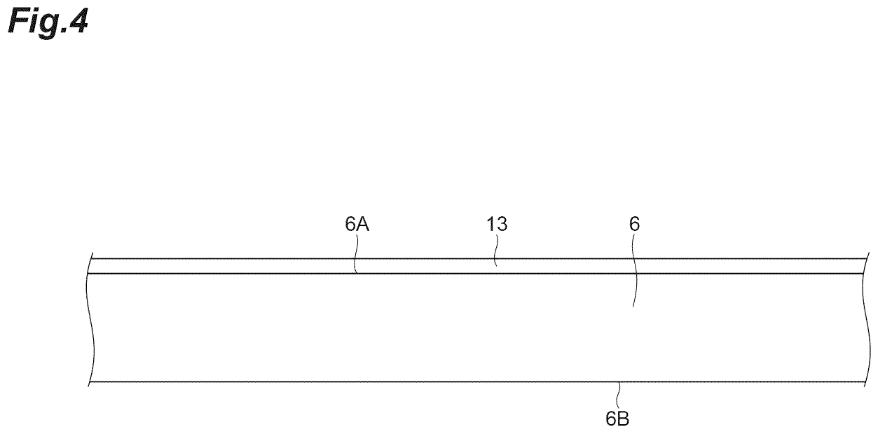

FIG. 4 is an enlarged view of a part of the first conductor 6. As shown in FIG. 4, the first conductor 6 has a first surface 6A and a second surface 6B. The first surface 6A and the second surface 6B face each other in the second direction D2. The first surface 6A is a surface facing the principal surface 2c (a surface facing the principal surface 2c side). The first surface 6A is a surface closer to the principal surface 2c than the second surface 6B in the second direction D2. The second surface 6B is a surface facing the principal surface 2d (a surface facing the principal surface 2d side). The second surface 6B is a surface closer to the principal surface 2d than the first surface 6A in the second direction D2.

An identification portion 13 is provided on the first surface 6A of the first conductor 6. In the present embodiment, the identification portion 13 is disposed on the entire surface of the first surface 6A. The thickness (dimension in the second direction D2) of the identification portion 13 is smaller than the thickness of the first conductor 6. The identification portion 13 is formed of a material different from that of the first conductor 6. The identification portion 13 is formed of a material having a higher light reflectance than that of the material forming the first conductor 6. That is, in the present embodiment, the identification portion 13 is formed of a material having a higher light reflectance than that of Cu. The identification portion 13 is formed of, for example, Cr, Ti, or NiCr.

As shown in FIG. 2, a distance L1 between the first conductor 6 and the principal surface 2c of the element body 2 is shorter than a distance L2 between the second conductor 7 and the principal surface 2d of the element body 2 (L1<L2). The distance L1 is set to a distance at which visible light incident from the principal surface 2c of the element body 2 can reach the identification portion 13. The distance L1 is set to, for example, 1 μm to 30 μm.

As described above, in the coil component 1 according to the present embodiment, the element body 2 is formed of a material having light permeability. In this configuration, the identification portion 13 formed of a material different from those of the first conductor 6 and the second conductor 7 is provided on the first surface 6A facing the principal surface 2c in the first conductor 6. As a result, in the coil component 1, the first conductor 6 and the second conductor 7 can be distinguished from the identification portion 13 when the element body 2 is viewed, so that the identification portion 13 can be recognized. Therefore, in the coil component 1, the first conductor 6 can be recognized by the identification portion 13, so that the orientation (position) of the first conductor 6 can be recognized. Therefore, in the coil component 1, the direction (orientation) of the coil component 1 can be identified.

In the coil component 1 according to the present embodiment, a material forming the identification portion 13 has a higher light reflectance than those of materials forming the first conductor 6 and the second conductor 7. Specifically, the first conductor 6 and the second conductor 7 are formed of a material containing Cu as a main component, and the identification portion 13 is formed of a material containing Cr, Ti, or NiCr as a main component. In this configuration, the first conductor 6 and the second conductor 7 have different light reflectances from that of the identification portion 13, so that the identification portion 13 can be more easily recognized.

In the coil component 1 according to the present embodiment, the first terminal electrode 3 and the second terminal electrode 4 are embedded in the element body 2. The surfaces of the first terminal electrode 3 and the second terminal electrode 4 do not protrude from the principal surface 2d of the element body 2. As described above, in the configuration in which the first terminal electrode 3 and the second terminal electrode 4 are embedded in the element body 2, it is difficult to recognize the first terminal electrode 3 and the second terminal electrode 4, so that it is difficult to recognize the direction of the coil component 1 at a glance. Therefore, the above configuration is particularly effective in the configuration in which the first terminal electrode 3 and the second terminal electrode 4 are embedded in the element body 2.

In the coil component 1 according to the present embodiment, the distance L1 between the first conductor 6 and the principal surface 2c is shorter than the distance L2 between the second conductor 7 and the principal surface 2d. As a result, in the coil component 1, the identification portion 13 provided in the first conductor 6 is more easily visually recognized than the second conductor 7 when the element body 2 is viewed, so that the identification portion 13 (first conductor 6) can be recognized. Therefore, in the coil component 1, the orientation (position) of the first conductor 6 can be recognized. Therefore, in the coil component 1, the direction (orientation) of the coil component 1 can be identified.

When the coil component 1 is manufactured, the laminated body is cut into individual pieces. At this time, the internal conductor may be exposed in the divided laminated body due to a deviation of the cutting position of the laminated body. Therefore, after manufacturing the coil component 1, it is inspected whether or not the internal conductor disposed in the element body 2 is exposed from the element body 2. As an inspection method, the appearance of the coil component 1 is checked, and the exposure of the first conductor 6 from the element body 2 is inspected. In the coil component 1 according to the present embodiment, the identification portion 13 is provided on the first surface 6A of the first conductor 6. The first conductor 6 and the identification portion 13 can be distinguished from each other, so that when the laminated body (element body 2) is scraped due to the deviation of the cutting position, it is possible to confirm whether or not the first conductor 6 is exposed by confirming whether or not the identification portion 13 is exposed or whether or not the first conductor 6 is exposed.

### Second Embodiment

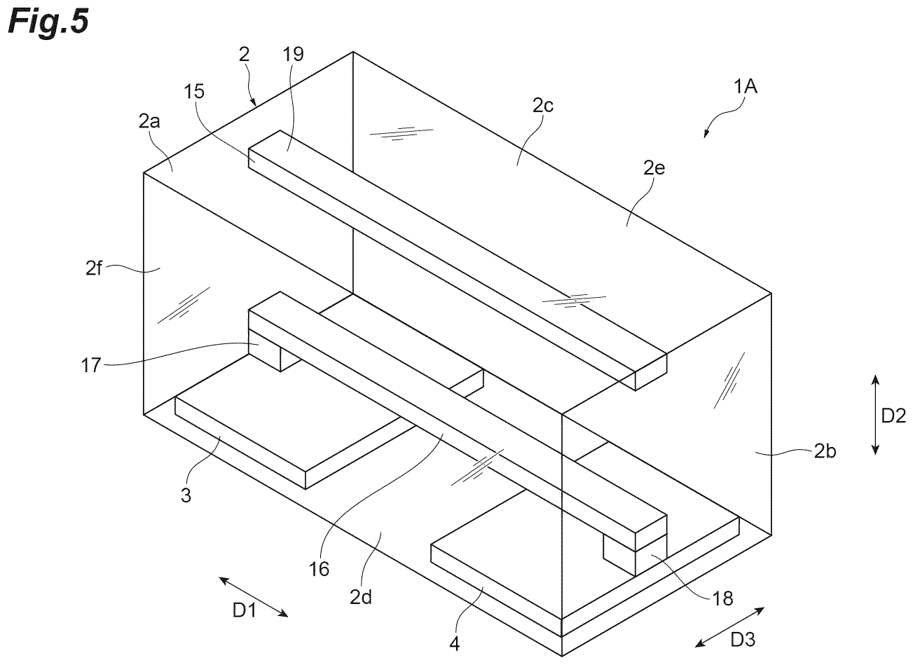

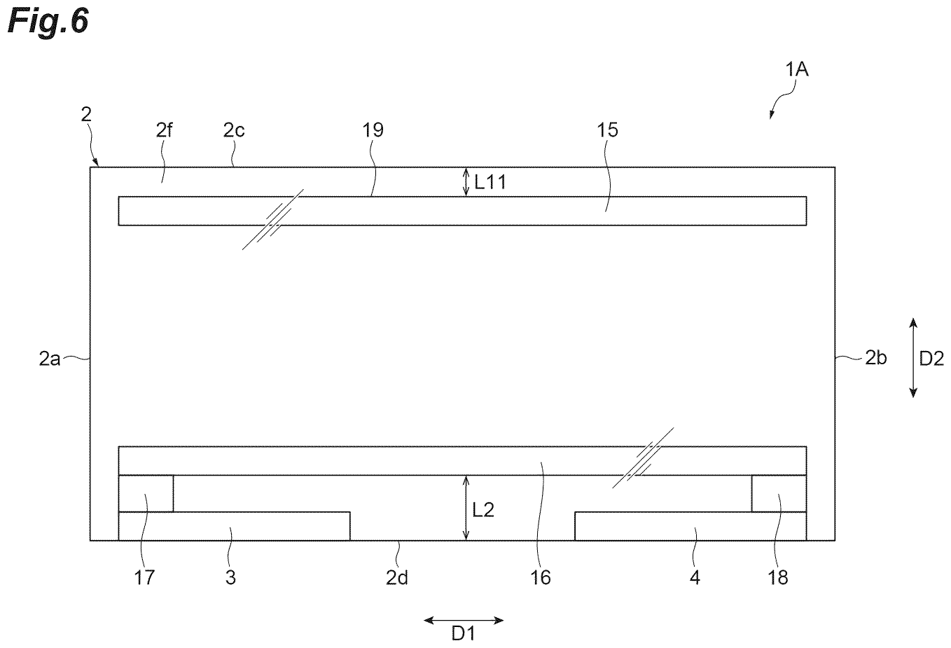

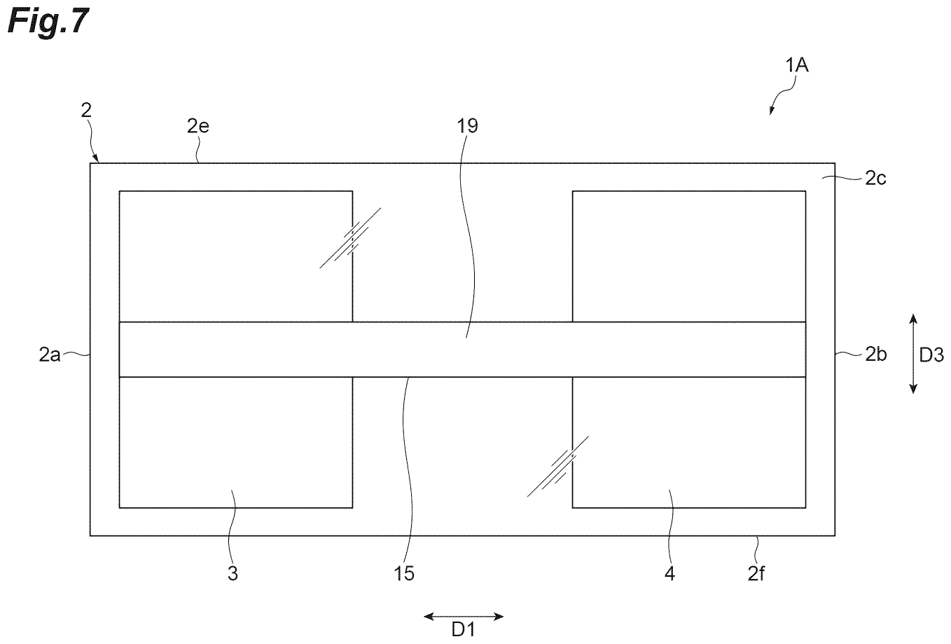

Next, an electronic component according to a second embodiment will be described. FIG. 5 is a perspective view of the electronic component according to the second embodiment. FIG. 6 is a view of the electronic component illustrated in FIG. 5 as viewed from a side surface side. FIG. 7 is a view of the electronic component illustrated in FIG. 5 as viewed from a principal surface side. As illustrated in FIGS. 5 to 7, a coil component (electronic component) 1A includes an element body 2, a first terminal electrode 3, a second terminal electrode 4, a first conductor 15, a second conductor 16, a first connection conductor 17, and a second connection conductor 18.

The first conductor 15 and the second conductor 16 are formed of a conductive material. In the present embodiment, the first conductor 15 and the second conductor 16 are formed of a material containing Cu as a main component. The first conductor 15 and the second conductor 16 are disposed apart from the end surfaces 2a and 2b, the principal surfaces 2c and 2d, and the side surfaces 2e and 2f.

The first conductor 15 is disposed at a position closer to the principal surface 2c of the element body 2. The first conductor 15 extends along the first direction D1. In the present embodiment, the first conductor 15 has a prismatic shape. The first conductor 15 has a rectangular cross section. The first conductor 15 is not electrically connected to the first terminal electrode 3 and the second terminal electrode 4. That is, the first conductor 15 is a so-called dummy electrode.

The second conductor 16 is disposed at a position closer to the principal surface 2d (mounting surface) of the element body 2. The second conductor 16 extends in the first direction D1. In the present embodiment, the second conductor 7 has a prismatic shape. The second conductor 7 has a rectangular cross section. In the present embodiment, the second conductor 16 has the same shape and size as those of the first conductor 15. The second conductor 16 is disposed at a position facing the first conductor 15 in the second direction D2. The second conductor 16 is disposed at a position overlapping the first conductor 15 as viewed from the second direction D2.

The first connection conductor 17 connects the first terminal electrode 3 and the second conductor 16. The first connection conductor 17 is connected to one end portion of the second conductor 16. The first connection conductor 17 is disposed at a position close to the end surface 2a. The first connection conductor 17 is made of a conductive material. The first connection conductor 17 is formed of, for example Cu.

The second connection conductor 18 connects the second terminal electrode 4 and the second conductor 16. The second connection conductor 18 is connected to the other end portion of the second conductor 16. The second connection conductor 18 is disposed at a position close to the end surface 2b. The second connection conductor 18 is made of a conductive material. The second connection conductor 18 is formed of, for example, Cu.

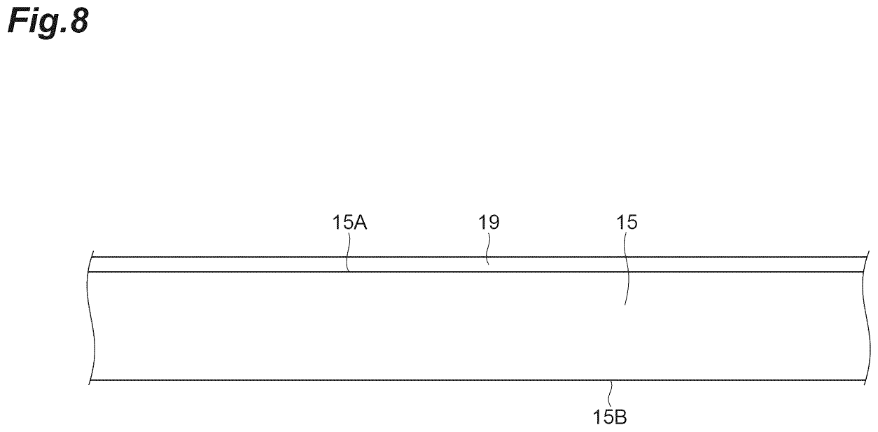

FIG. 8 is an enlarged view of a part of the first conductor 15. As shown in FIG. 8, the first conductor 15 has a first surface 15A and a second surface 15B. The first surface 15A and the second surface 15B face each other in the second direction D2. The first surface 15A is a surface facing the principal surface 2c (a surface facing the principal surface 2c side). The first surface 15A is a surface closer to the principal surface 2c than the second surface 15B in the second direction D2. The second surface 15B is a surface facing the principal surface 2d (a surface facing the principal surface 2d side). The second surface 15B is a surface closer to the principal surface 2d than the first surface 15A in the second direction D2.

An identification portion 19 is provided on the first surface 15A of the first conductor 15. In the present embodiment, the identification portion 19 is disposed on the entire surface of the first surface 15A. The thickness (dimension in the second direction D2) of the identification portion 19 is smaller than the thickness of the first conductor 15. The identification portion 19 is formed of a material different from that of the first conductor 15. The identification portion 19 is formed of a material having a higher light reflectance than that of the material forming the first conductor 15. That is, in the present embodiment, the identification portion 19 is formed of a material having a higher light reflectance than that of Cu. The identification portion 19 is formed of, for example, Cr, Ti, or NiCr.

As shown in FIG. 6, a distance L11 between the first conductor 15 and the principal surface 2c of the element body 2 is shorter than a distance L12 between the second conductor 16 and the principal surface 2d of the element body 2 (L11<L12). The distance L11 is set to a distance at which visible light incident from the principal surface 2c of the element body 2 can reach the identification portion 19. The distance L11 is set to, for example, 1 μm to 30 μm.

As described above, in the coil component 1A according to the present embodiment, the element body 2 is formed of a material having light permeability. In this configuration, the identification portion 19 formed of a material different from those of the first conductor 15 and the second conductor 16 on the first surface 15A facing the principal surface 2c is provided on the first conductor 15. As a result, in the coil component 1A, the first conductor 15 and the second conductor 16 can be distinguished from the identification portion 19 when the element body 2 is viewed, so that the identification portion 19 can be recognized. Therefore, in the coil component 1A, the first conductor 15 can be recognized by the identification portion 19, so that the orientation (position) of the first conductor 15 can be recognized. Therefore, in the coil component 1A, the direction (orientation) of the coil component 1A can be identified.

In the coil component 1A according to the present embodiment, the material forming the identification portion 19 has a higher light reflectance than those of materials forming the first conductor 15 and the second conductor 16. Specifically, the first conductor 15 and the second conductor 16 are formed of a material containing Cu as a main component, and the identification portion 19 is formed of a material containing Cr, Ti, or NiCr as a main component. In this configuration, the first conductor 15 and the second conductor 16 have different light reflectances from that of the identification portion 19, so that the identification portion 19 can be more easily recognized.

In the coil component 1A according to the present embodiment, the distance L11 between the first conductor 15 and the principal surface 2c is shorter than the distance L12 between the second conductor 16 and the principal surface 2d. As a result, in the coil component 1A, the identification portion 19 provided in the first conductor 15 is more easily visually recognized than the second conductor 16 when the element body 2 is viewed, so that the identification portion 19 (first conductor 15) can be recognized. Therefore, in the coil component 1A, the orientation (position) of the first conductor 15 can be recognized. Therefore, in the coil component 1A, the direction (orientation) of the coil component 1A can be identified.

In the coil component 1A according to the present embodiment, the first conductor 15 is not electrically connected to the first terminal electrode 3 and the second terminal electrode 4, and the second conductor 16 is electrically connected to the first terminal electrode 3 and the second terminal electrode 4. The first conductor 15 is a so-called dummy conductor. In this configuration, even when the inductor includes only the second conductor 16, the first conductor 15 that is the dummy conductor is provided, so that the first conductor 15 can be recognized. Therefore, in the coil component 1A, the orientation (position) of the first conductor 15 can be recognized. Therefore, in the coil component 1A, the direction (orientation) of the coil component 1A can be identified.

Although the embodiment of the present disclosure has been described in the foregoing, the present disclosure is not necessarily limited to the above-described embodiment, and various modifications can be made without departing from the gist thereof.

In the above-described embodiment, the aspect in which the identification portions 13 and 19 are provided on the first surfaces 6A and 15A of the first conductors 6 and 15 has been described as an example. However, the identification portions 13 and 19 may not be provided. In this case, the distances L1, L11 between the first conductors 6, 15 and the principal surface 2c of the element body 2 may be shorter than the distances L2, L12 between the second conductors 7, 16 and the principal surface 2d of the element body 2. In this configuration, the identification portions 13 and 19 provided in the first conductors 6 and 15 are more easily visually recognized than the second conductors 7 and 16 when the element body 2 is viewed, so that the identification portions 13 and 19 (first conductors 6 and 15) can be recognized. Therefore, the orientation (position) of the first conductors 6 and 15 can be recognized. Therefore, the direction (orientation) of the coil component can be identified.

In the above embodiment, the aspect in which the identification portions 13 and 19 are provided on the entire first surfaces 6A and 15A of the first conductors 6 and 15 has been described as an example. However, the identification portions 13 and 19 may be provided on a part of the first surfaces 6A and 15A of the first conductors 6 and 15.

In the above second embodiment, the aspect in which the first conductor 15 is not electrically connected to the first terminal electrode 3 and the second terminal electrode 4 has been described as an example. That is, the aspect in which the first conductor 15 is the dummy conductor has been described as an example. However, the first conductor 15 may be electrically connected to the first terminal electrode 3 and the second terminal electrode 4.

In the above second embodiment, the aspect in which each of the number of the first conductors 15 and the number of the second conductors 16 is one has been described as an example. However, a plurality of first conductors 15 and a plurality of second conductors 16 may be provided.

In the above embodiment, the aspect in which the first terminal electrode 3 and the second terminal electrode 4 are embedded in the element body 2 has been described as an example. The first terminal electrode 3 and the second terminal electrode 4 may be disposed on the principal surface 2d of the element body 2.

In the above embodiment, the numbers of the first conductors, the second conductors, and the pillars are not limited to the above-described values. The shapes of the first conductor, the second conductor, and the pillar are not limited to the above-described shapes.

What is claimed is:

1. An electronic component comprising:
an element body formed by laminating a plurality of insulating layers, and including a mounting surface and a principal surface facing the mounting surface;
a pair of terminal electrodes disposed on the mounting surface of the element body;
a first conductor disposed at a position close to the principal surface in the element body and electrically connected to the pair of terminal electrodes; and
a second conductor disposed at a position closer to the mounting surface in the element body and electrically connected to the pair of terminal electrodes, wherein
the element body is formed of a material having light permeability, and
an identification portion formed of a material different from a material of the first conductor is provided on a surface of the first conductor facing the principal surface.

2. The electronic component according to claim 1, wherein the material forming the identification portion has a higher light reflectance than a light reflectance of the material forming the first conductor.

3. The electronic component according to claim 1, wherein
the first conductor is formed of a material containing Cu as a main component, and
the identification portion is formed of a material containing Cr, Ti, or NiCr as a main component.

4. The electronic component according to claim 1, further comprising a connection conductor disposed in the element body, extending in a direction in which the mounting surface and the principal surface face each other, and connecting the first conductor and the second conductor.

5. The electronic component according to claim 1, wherein
the pair of terminal electrodes is embedded in the element body, and
surfaces of the pair of terminal electrodes do not protrude from the mounting surface.

6. An electronic component comprising:
an element body formed by laminating a plurality of insulating layers, and including a mounting surface and a principal surface facing the mounting surface;
a pair of terminal electrodes disposed on the mounting surface of the element body;
a first conductor disposed at a position closer to the principal surface in the element body; and
a second conductor disposed at a position closer to the mounting surface in the element body, wherein
the element body is formed of a material having light permeability, and
a distance between the first conductor and the principal surface is shorter than a distance between the second conductor and the mounting surface.

7. The electronic component according to claim 6, wherein
the first conductor is not electrically connected to the pair of terminal electrodes, and
the second conductor is electrically connected to the pair of terminal electrodes.

8. The electronic component according to claim 6, wherein the first conductor and the second conductor are formed of a material containing Cu as a main component.

9. The electronic component according to claim 6, further comprising a connection conductor disposed in the element body, extending in a direction in which the mounting surface and the principal surface face each other, and connecting the first conductor and the second conductor.

10. The electronic component according to claim 6, wherein
the pair of terminal electrodes is embedded in the element body, and
surfaces of the pair of terminal electrodes do not protrude from the mounting surface.
